(19) United States
(12) Patent Application Publication
(10) Pub. No.: US 2026/0336596 A1
(43) Pub. Date: Oct. 29, 2026

(54) METHOD FOR OPTIMISING A CRITERION OR A COMBINATION OF CRITERIA RELATING TO A MOTOR VEHICLE

(71) Applicant: SCHAEFFLER TECHNOLOGIES AG & CO. KG, Herzogenaurach (DE)

(72) Inventor: Mariano SANS, Toulouse (FR)

(73) Assignee: SCHAEFFLER TECHNOLOGIES AG & CO. KG, Herzogenaurach (DE)

(21) Appl. No.: 19/104,939

(22) PCT Filed: Sep. 15, 2023
(86) PCT No.: PCT/EP2023/075385

§ 371 Date: Feb. 19, 2025

(30) Foreign Application Priority Data
Sep. 29, 2022 (FR) FR2209868

(51) Int. Cl. B60W 20/12; B60W 20/16

(52) U.S. Cl. CPC B60W 20/12; B60W 20/16

(57) ABSTRACT

A method for optimizing a criterion or a combination of criteria relating to a motor vehicle including a fuel or hydrogen tank, a battery and/or super-capacitors, an internal combustion engine or a fuel cell, an electric machine, a plurality of devices, each characterized by at least one state variable, and a computer configured to manage the powertrain of the motor vehicle on a predetermined route and being capable of controlling the internal combustion engine or fuel cell, electric machine (ME) and/or devices through transmission of a set of setpoints. A computer and a computer program product for implementing such a method, and to a motor vehicle including such a computer as also disclosed.

### CROSS-REFERENCE TO RELATED APPLICATIONS

This application is the U.S. National Phase Application of PCT International Application No. PCT/EP2023/075385, filed Sep. 15, 2023, which claims priority to French Patent Application No. FR2209868, filed Sep. 29, 2022, the contents of such applications being incorporated by reference herein.

### FIELD OF THE INVENTION

The present invention relates to optimization of a criterion or a combination of criteria relating to a motor vehicle, and more particularly to a method for optimizing a criterion or a combination of criteria of a motor vehicle on a predefined route. The invention in particular aims to generate optimized setpoints for controlling the vehicle on said route to be traveled, thereby minimizing the criterion or the combination of criteria. The criterion to be optimized is typically a pollution level, an energy consumption, a state of health of the vehicle or a duration of a predetermined route of the vehicle. The combination of criteria to be optimized consists of a combination of at least two criteria selected from the group consisting of: a pollution level, an energy consumption, a state of health and a duration of a predetermined route. By “energy consumption of the vehicle”, what is meant in the context of the present invention is a consumption in fuel, in hydrogen, in electrical energy, in electrical current delivered by the terminals of an electronic charger of an electric battery of the vehicle, in number of times a range extender of a series hybrid vehicle is started up, or even a combined consumption of a plurality of these elements. By “state of health of the vehicle”, what is meant in the context of the present invention is a percentage that varies from 100% to 0% and that makes it possible to characterize the level of deterioration of an electric battery and/or of one or more super-capacitors and/or of a fuel cell of the vehicle, taking into account replacement and maintenance costs.

### BACKGROUND OF THE INVENTION

In a motor vehicle, it is known practice to optimize the energy consumption of the powertrain on a given or predicted route. Such an optimization may be carried out on fuel, on electrical energy, on hydrogen consumption (in the case of a vehicle equipped with a fuel cell) or on two or three of these criteria at once.

As is known, the optimization may be carried out using the principle known by the name Pontryagin's maximum principle (PMP). This method consists in minimizing the Hamiltonian function (or Hamiltonian) on the basis of the criterion to be optimized, for example the amount of fuel or hydrogen or even the electrical energy consumed, and the description of the dynamics of the system. The dynamics of the system are defined on the basis of the state of various variables of the vehicle (speed of the vehicle, state of charge of the battery and/or super-capacitors, temperatures, etc.) and various inputs or setpoints (torque setpoints to be applied to the wheels of the vehicle by the internal combustion engine or by one or more electric machines, torque setpoints to be applied by the one or more motors of the range extender, and/or power or current setpoints for the fuel cell, and/or even setpoints for heating the catalytic converter, and/or indeed setpoints for controlling the cooling circuit, etc.). The Hamiltonian function is minimized in order to determine the setpoints that make it possible to obtain the minimum consumption of fuel or hydrogen, and/or of electrical energy.

Each input or setpoint is dependent on the state of certain variables. For example, the torque setpoint to be applied by the electric machine to the wheels of the vehicle is dependent on the speed of the vehicle and on the state of charge of the battery, the setpoint for controlling the cooling circuit is dependent on the temperature in real time in the cooling circuit, and the setpoint for heating the catalytic converter is dependent on the temperature in real time in the catalytic converter.

The Hamiltonian determined in this way is then minimized. In other words, the values of the setpoints for which the value of the Hamiltonian is lowest are selected and applied to the vehicle. The setpoint values are thus determined in real time depending on the current state of the system.

Application of such a PMP model thus uses an internal model describing the dynamics of the system to be controlled (here the motor vehicle and its powertrain), via differential equations representing the system. Such a PMP model is therefore mainly based on an optimum open-loop control strategy that computes the optimum control solution depending on the predictions of the internal model, with very little feedback from current measurements on the system. When the internal model differs very little from the actual physical system, use of such a PMP model provides a solution that is acceptable from the point of view of accuracy, and hence the model leads to a correct optimum solution. However, the internal model may differ from the actual physical system, due in particular to model simplifications, external disturbances, aging effects, etc. The result provided by such a model then suffers from a lack of accuracy and/or stability from the point of view of the optimization control strategy employed.

There is therefore a need to be able to provide an optimum control method that allows optimization of a criterion or a combination of criteria relating to a motor vehicle through implementation of a PMP model, while being self-adaptive in order to take account, in an iterative manner, of deviations from the actual physical system of which the vehicle consists.

The document “Adaptive Control of a Hybrid Powertrain with Map-based ECMS-IFAC proceedings—Vol 44, Issue 1, 2011, p2949-2954” describes an optimum self-adaptive control strategy applied to (fuel cell and battery) hybrid vehicles. The optimum control strategy implements a principle known as the equivalent consumption minimization strategy (ECMS). The optimum control strategy implemented by this ECMS principle consists in considering the electric battery of the vehicle to be an auxiliary fuel tank, this making it possible to choose at any time the control strategy minimizing the total energy drawn from the two tanks (the hydrogen tank being the main tank, and the electric battery being an auxiliary tank) by introducing equivalence factors allowing the various consumptions to be transposed to the same energy space. However, such a self-adaptive control strategy does not employ equations known as “optimality conditions” using the necessary “co-states” or “dual variables”, and cannot be transferred as such to an optimum control method implementing a PMP model.

Therefore, there is a need for a solution allowing these drawbacks to be at least partially overcome.

To this end and according to a first aspect, the invention relates to a method, implemented in a computer embedded within a motor vehicle, for optimizing a pollution level of the vehicle, the vehicle comprising a fuel or hydrogen tank, an electric battery and/or super-capacitors capable of supplying electrical energy, an internal combustion engine powered by the fuel tank or a fuel cell powered by the hydrogen tank, at least one electric machine powered by electrical energy supplied by the battery and/or super-capacitors, at least one device relating to the internal combustion engine or to the fuel cell, at least one device relating to the electric machine, and at least one device relating to the electric battery or to the super-capacitors, the computer being configured to manage the powertrain of the motor vehicle on a predetermined route and being capable of controlling the internal combustion engine or fuel cell, electric machine and/or devices through transmission of a set of setpoints, the internal combustion engine or the fuel cell, the electric machine, and the devices each being characterized by at least one state variable, each state variable making it possible to describe the operating state of the device that it characterizes, the set consisting of the internal combustion engine or fuel cell, of the electric machine, and of the devices being represented by a system of state equations modeling the dynamics of the vehicle, said state equations being dependent at least on instantaneous setpoint values and the state variables, the pollution level to be optimized being represented by a criterion equation dependent at least on instantaneous setpoint values and the state variables, the vehicle further comprising means for measuring the one or more states described by the or each state variable and means for measuring the pollution level of the vehicle, said method being implemented during a period divided into constant sampling times, the method comprising, at each sampling time, the steps of:
a) determining an applicable setpoint range containing a set of values for each setpoint,
b) computing, for each setpoint and in the determined applicable setpoint range, all the state gradients possible for said setpoint, using at least the state equations,
c) computing, for each setpoint and in the determined applicable setpoint range, all the values possible for the pollution level to be optimized, using at least the criterion equation,
d) computing, for each setpoint and in the determined applicable setpoint range, all the possible values of a Hamiltonian function of said setpoint, using the state-gradient values and the values possible for the pollution level to be optimized determined for said setpoint,
e) determining the value of each setpoint, in the determined applicable setpoint range, for which said Hamiltonian function is lowest,
f) computing, for each of the setpoints, depending on said determined value of the setpoint, the state-gradient value for said setpoint, and/or computing, for each of the setpoints, depending on said determined value of the setpoint, the value of the pollution level for said setpoint,
g) integrating as a function of time the computed state-gradient value, so as to provide an estimated state value, and/or integrating as a function of time the computed value of the pollution level, so as to provide an estimated overall pollution-level value,
h) comparing the estimated state value with a measured state value, the difference between the two values providing a first correction term, the first correction term thus determined being provided as input to computing step b) at the next sampling time and being used in said computing step b), and/or comparing the estimated overall pollution-level value with a measured pollution-level value, the difference between the two values providing a second correction term, the second correction term thus determined being provided as input to computing step c) at the next sampling time and being used in said computing step c).

According to a second aspect, the invention also relates to a method, implemented in a computer embedded within a motor vehicle, for optimizing the energy consumption of the vehicle, the vehicle comprising a fuel or hydrogen tank, an electric battery and/or super-capacitors capable of supplying electrical energy, an internal combustion engine powered by the fuel tank or a fuel cell powered by the hydrogen tank, at least one electric machine powered by electrical energy supplied by the battery and/or super-capacitors, at least one device relating to the internal combustion engine or to the fuel cell, at least one device relating to the electric machine, and at least one device relating to the electric battery or to the super-capacitors, the computer being configured to manage the powertrain of the motor vehicle on a predetermined route and being capable of controlling the internal combustion engine or fuel cell, electric machine and/or devices through transmission of a set of setpoints, the internal combustion engine or the fuel cell, the electric machine, and the devices each being characterized by at least one state variable, each state variable making it possible to describe the operating state of the device that it characterizes, the set consisting of the internal combustion engine or fuel cell, of the electric machine, and of the devices being represented by a system of state equations modeling the dynamics of the vehicle, said state equations being dependent at least on instantaneous setpoint values and the state variables, the energy consumption to be optimized being represented by a criterion equation dependent at least on instantaneous setpoint values and the state variables, the vehicle further comprising means for measuring the one or more states described by the or each state variable and means for measuring the energy consumption of the vehicle, said method being implemented during a period divided into constant sampling times, the method comprising, at each sampling time, the steps of:
i) determining an applicable setpoint range containing a set of values for each setpoint,
j) computing, for each setpoint and in the determined applicable setpoint range, all the state gradients possible for said setpoint, using at least the state equations,
k) computing, for each setpoint and in the determined applicable setpoint range, all the values possible for the energy consumption to be optimized, using at least the criterion equation,
l) computing, for each setpoint and in the determined applicable setpoint range, all the possible values of a Hamiltonian function of said setpoint, using the state-gradient values and the values possible for the energy consumption to be optimized determined for said setpoint,
m) determining the value of each setpoint, in the determined applicable setpoint range, for which said Hamiltonian function is lowest,
n) computing, for each of the setpoints, depending on said determined value of the setpoint, the state-gradient value for said setpoint, and/or computing, for each of the setpoints, depending on said determined value of the setpoint, the value of the energy consumption for said setpoint,
o) integrating as a function of time the computed state-gradient value, so as to provide an estimated state value, and/or integrating as a function of time the computed value of the energy consumption, so as to provide an estimated overall energy-consumption value,
p) comparing the estimated state value with a measured state value, the difference between the two values providing a first correction term, the first correction term thus determined being provided as input to computing step j) at the next sampling time and being used in said computing step j), and/or comparing the estimated overall energy-consumption value with a measured energy-consumption value, the difference between the two values providing a second correction term, the second correction term thus determined being provided as input to computing step k) at the next sampling time and being used in said computing step k).

According to a third aspect, the invention also relates to a method, implemented in a computer embedded within a motor vehicle, for optimizing a state of health of the vehicle, the vehicle comprising a fuel or hydrogen tank, an electric battery and/or super-capacitors capable of supplying electrical energy, an internal combustion engine powered by the fuel tank or a fuel cell powered by the hydrogen tank, at least one electric machine powered by electrical energy supplied by the battery and/or super-capacitors, at least one device relating to the internal combustion engine or to the fuel cell, at least one device relating to the electric machine, and at least one device relating to the electric battery or to the super-capacitors, the computer being configured to manage the powertrain of the motor vehicle on a predetermined route and being capable of controlling the internal combustion engine or fuel cell, electric machine and/or devices through transmission of a set of setpoints, the internal combustion engine or the fuel cell, the electric machine, and the devices each being characterized by at least one state variable, each state variable making it possible to describe the operating state of the device that it characterizes, the set consisting of the internal combustion engine or fuel cell, of the electric machine, and of the devices being represented by a system of state equations modeling the dynamics of the vehicle, said state equations being dependent at least on instantaneous setpoint values and the state variables, the state of health to be optimized being represented by a criterion equation dependent at least on instantaneous setpoint values and the state variables, the vehicle further comprising means for measuring the one or more states described by the or each state variable and means for measuring the state of health of the vehicle, said method being implemented during a period divided into constant sampling times, the method comprising, at each sampling time, the steps of:
q) determining an applicable setpoint range containing a set of values for each setpoint,
r) computing, for each setpoint and in the determined applicable setpoint range, all the state gradients possible for said setpoint, using at least the equations,
s) computing, for each setpoint and in the determined applicable setpoint range, all the values possible for the state of health to be optimized, using at least the criterion equation,
t) computing, for each setpoint and in the determined applicable setpoint range, all the possible values of a Hamiltonian function of said setpoint, using the state-gradient values and the values possible for the state of health to be optimized determined for said setpoint,
u) determining the value of each setpoint, in the determined applicable setpoint range, for which said Hamiltonian function is lowest,
v) computing, for each of the setpoints, depending on said determined value of the setpoint, the state-gradient value for said setpoint, and/or computing, for each of the setpoints, depending on said determined value of the setpoint, the value of the state of health for said setpoint,
w) integrating as a function of time the computed state-gradient value, so as to provide an estimated state value, and/or integrating as a function of time the computed value of the state of health, so as to provide an estimated overall state-of-health value,
x) comparing the estimated state value with a measured state value, the difference between the two values providing a first correction term, the first correction term thus determined being provided as input to computing step r) at the next sampling time and being used in said computing step r), and/or comparing the estimated overall state-of-health value with a measured state-of-health value, the difference between the two values providing a second correction term, the second correction term thus determined being provided as input to computing step s) at the next sampling time and being used in said computing step s).

According to a fourth aspect, the invention also relates to a method, implemented in a computer embedded within a motor vehicle, for optimizing a duration of a predetermined route of the vehicle, the vehicle comprising a fuel or hydrogen tank, an electric battery and/or super-capacitors capable of supplying electrical energy, an internal combustion engine powered by the fuel tank or a fuel cell powered by the hydrogen tank, at least one electric machine powered by electrical energy supplied by the battery and/or super-capacitors, at least one device relating to the internal combustion engine or to the fuel cell, at least one device relating to the electric machine, and at least one device relating to the electric battery or to the super-capacitors, the computer being configured to manage the powertrain of the motor vehicle on a predetermined route and being capable of controlling the internal combustion engine or fuel cell, electric machine and/or devices through transmission of a set of setpoints, the internal combustion engine or the fuel cell, the electric machine, and the devices each being characterized by at least one state variable, each state variable making it possible to describe the operating state of the device that it characterizes, the set consisting of the internal combustion engine or fuel cell, of the electric machine, and of the devices being represented by a system of state equations modeling the dynamics of the vehicle, said state equations being dependent at least on instantaneous setpoint values and the state variables, the duration of the predetermined route to be optimized being represented by a criterion equation dependent at least on instantaneous setpoint values and the state variables, the vehicle further comprising means for measuring the one or more states described by the or each state variable and means for measuring the duration of the predetermined route of the vehicle, said method being implemented during a period divided into constant sampling times, the method comprising, at each sampling time, the steps of:
y) determining an applicable setpoint range containing a set of values for each setpoint,
z) computing, for each setpoint and in the determined applicable setpoint range, all the state gradients possible for said setpoint, using at least the state equations,
aa) computing, for each setpoint and in the determined applicable setpoint range, all the values possible for the duration of the predetermined route to be optimized, using at least the criterion equation,
bb) computing, for each setpoint and in the determined applicable setpoint range, all the possible values of a Hamiltonian function of said setpoint, using the state-gradient values and the values possible for the duration of the predetermined route to be optimized determined for said setpoint,
cc) determining the value of each setpoint, in the determined applicable setpoint range, for which said Hamiltonian function is lowest,
dd) computing, for each of the setpoints, depending on said determined value of the setpoint, the state-gradient value for said setpoint, and/or computing, for each of the setpoints, depending on said determined value of the setpoint, the value of the route duration for said setpoint,
ee) integrating as a function of time the computed state-gradient value, so as to provide an estimated state value, and/or integrating as a function of time the computed value of the route duration, so as to provide an estimated overall route-duration value,
ff) comparing the estimated state value with a measured state value, the difference between the two values providing a first correction term, the first correction term thus determined being provided as input to computing step z) at the next sampling time and being used in said computing step z), and/or comparing the estimated overall route-duration value with a measured route-duration value, the difference between the two values providing a second correction term, the second correction term thus determined being provided as input to computing step aa) at the next sampling time and being used in said computing step aa).

According to a fifth aspect, the invention also relates to a method, implemented in a computer embedded within a motor vehicle, for optimizing a combination of at least two criteria relating to the vehicle and selected from the group consisting of: a pollution level, an energy consumption, a state of health and a duration of a predetermined route, the vehicle comprising a fuel or hydrogen tank, an electric battery and/or super-capacitors capable of supplying electrical energy, an internal combustion engine powered by the fuel tank or a fuel cell powered by the hydrogen tank, at least one electric machine powered by electrical energy supplied by the battery and/or super-capacitors, at least one device relating to the internal combustion engine or to the fuel cell, at least one device relating to the electric machine, and at least one device relating to the electric battery or to the super-capacitors, the computer being configured to manage the powertrain of the motor vehicle on said predetermined route and being capable of controlling the internal combustion engine or fuel cell, electric machine and/or devices through transmission of a set of setpoints, the internal combustion engine or the fuel cell, the electric machine, and the devices each being characterized by at least one state variable, each state variable making it possible to describe the operating state of the device that it characterizes, the set consisting of the internal combustion engine or fuel cell, of the electric machine, and of the devices being represented by a system of state equations modeling the dynamics of the vehicle, said state equations being dependent at least on instantaneous setpoint values and the state variables, the combination of criteria to be optimized being represented by a criterion equation dependent at least on instantaneous setpoint values and the state variables, the vehicle further comprising means for measuring the one or more states described by the or each state variable and means for measuring each of the criteria of the combination of criteria to be optimized, said method being implemented during a period divided into constant sampling times, the method comprising, at each sampling time, the steps of:
gg) determining an applicable setpoint range containing a set of values for each setpoint,
hh) computing, for each setpoint and in the determined applicable setpoint range, all the state gradients possible for said setpoint, using at least the state equations,
ii) computing, for each setpoint and in the determined applicable setpoint range, all the values possible for the combination of criteria to be optimized, using at least the criterion equation,
jj) computing, for each setpoint and in the determined applicable setpoint range, all the possible values of a Hamiltonian function of said setpoint, using the state-gradient values and the values possible for the combination of criteria to be optimized determined for said setpoint,
kk) determining the value of each setpoint, in the determined applicable setpoint range, for which said Hamiltonian function is lowest,
ll) computing, for each of the setpoints, depending on said determined value of the setpoint, the state-gradient value for said setpoint, and/or computing, for each of the setpoints, depending on said determined value of the setpoint, the value of each criterion of the combination of criteria for said setpoint,
mm) integrating as a function of time the computed state-gradient value, so as to provide an estimated state value, and/or integrating as a function of time, for each criterion of the combination of criteria, the computed value of that criterion, so as to provide an estimated overall criterion value,
nn) comparing the estimated state value with a measured state value, the difference between the two values providing a first correction term, the first correction term thus determined being provided as input to computing step hh) at the next sampling time and being used in said computing step hh), and/or comparing, for each criterion of the combination of criteria, the estimated overall criterion value with a measured criterion value, the difference between the two values providing a second correction term, the second correction term thus determined being provided as input to computing step ii) at the next sampling time and being used in said computing step ii).

In each of the methods described above, the steps are looped through iteratively at each new sampling time. Furthermore, each of the methods is implemented for a predefined/given route for the vehicle. Such a route is for example predicted by an eHorizon system (conventionally based, for predictive driver-assistance systems, on the ADASIS data format, ADASIS standing for Advanced Driver-Assistance Systems Interface Specifications, or on any other type of mechanism) that is connected to the computer of the vehicle. As is known per se, such an eHorizon system makes it possible to manage both static data relating to road infrastructure (such as for example the nature of roads and intersections, statutory speed limits in force, etc.), and dynamic data (average speed of vehicles using the road, traffic density, dynamic data relating to pieces of road infrastructure, etc.). Such an eHorizon system is capable of receiving these data, of decoding them (via a decoder), of reconstructing them (via a data reconstructor), and of transmitting them to the computer of the vehicle, and is capable of implementing algorithms for predicting vehicle path based on most probable path.

Each of the methods according to aspects of the invention makes it possible to define torque setpoints in order to provide the power and acceleration requested by the driver during operation of the vehicle on the given or predicted route, while minimizing the pollution level, energy consumption and/or decrease in the state of health of the vehicle. In addition, through computation and determination of first and second correction terms, which are fed back to the first computing steps via a feedback loop, each of the method makes it possible to simulate the behavior of the model at each sampling time and to compare it in real time with the behavior of the physical system in question (the vehicle and its powertrain). Each method uses the direct state equations of the PMP model in steps that make it possible to determine the first and second correction terms, in an integrated “observer” strategy. This allows the parameters of the model to be adapted and to make them correspond better to the actual physical system (the vehicle and its powertrain). Such an optimum closed-loop control strategy (with feedback) is therefore self-adaptive, in the sense that the parameters of the model are adjusted at each sampling time depending on the behavior of the physical system, this making each method according to aspects of the invention more accurate and/or more stable from the point of view of the optimization control strategy, compared to the methods of the prior art.

Preferably, the steps of computing, for each of the setpoints, the state-gradient value and the value of the criterion, the steps of integration as a function of time, and the comparing steps are all implemented in each of the methods according to aspects of the invention. In other words, in each of the methods according to aspects of the invention, the first and second correction terms are preferably determined and provided as input to the first computing steps.

Preferably, the first correction term or second correction term, respectively, is used in the computing step via a mathematical relationship of addition or multiplication with the state equations or with the criterion equation, respectively.

Preferably, the or each comparing step is implemented via proportional-integral-derivative regulation, by a regulator embedded within the vehicle, or via state-variable re-estimation.

An aspect of the invention also relates to a computer for managing the powertrain of a motor vehicle on a predetermined route, the vehicle comprising, in addition to the computer, a fuel or hydrogen tank, an electric battery and/or super-capacitors capable of supplying electrical energy, an internal combustion engine powered by the fuel tank or a fuel cell powered by the hydrogen tank, at least one electric machine powered by electrical energy supplied by the battery and/or super-capacitors, at least one device relating to the internal combustion engine or to the fuel cell, at least one device relating to the electric machine, and at least one device relating to the electric battery or to the super-capacitors, the computer being capable of controlling the internal combustion engine or the fuel cell, the electric machine and/or devices through transmission of a set of setpoints, the internal combustion engine or the fuel cell, the electric machine, and the devices each being characterized by at least one state variable, each state variable making it possible to describe the operating state of the device that it characterizes, the set consisting of the internal combustion engine or fuel cell, of the electric machine, and of the devices being represented by a system of state equations modeling the dynamics of the vehicle, said state equations being dependent at least on instantaneous setpoint values and the state variables, the vehicle further comprising means for measuring the one or more states described by the or each state variable and means for measuring a criterion or a combination of criteria of the vehicle to be optimized, the computer being configured to implement the steps of one of the methods such as described above.

An aspect of the invention also relates to a motor vehicle comprising a fuel or hydrogen tank, an electric battery and/or super-capacitors capable of supplying electrical energy, an internal combustion engine powered by the fuel tank or a fuel cell powered by the hydrogen tank, at least one electric machine powered by electrical energy supplied by the battery and/or the super-capacitors, at least one device relating to the internal combustion engine or to the fuel cell, at least one device relating to the electric battery or to the super-capacitors, and a computer for managing the powertrain of a motor vehicle on a predetermined route, the computer being capable of controlling the internal combustion engine or fuel cell, electric machine and/or devices through transmission of a set of setpoints, the internal combustion engine or the fuel cell, the electric machine, and the devices each being characterized by at least one state variable, each state variable making it possible to describe the operating state of the device that it characterizes, the set consisting of the internal combustion engine or fuel cell, of the electric machine, and of the devices being represented by a system of state equations modeling the dynamics of the vehicle, said state equations being dependent at least on instantaneous setpoint values and the state variables, the vehicle further comprising means for measuring the one or more states described by the or each state variable and means for measuring a criterion or a combination of criteria of the vehicle to be optimized, and a computer such as described for managing the powertrain.

An aspect of the invention also relates to a computer program product, noteworthy in that it comprises a set of program code instructions, which, when they are executed by one or more processors, configure the one or more processors to implement one of the methods such as described above.

### BRIEF DESCRIPTION OF THE DRAWINGS

Embodiments of the present invention will be described below by way of non-limiting examples and with reference to the appended figures, in which:

FIG. 1 schematically illustrates a vehicle according to an aspect of the invention, the vehicle being equipped with an embedded computer; and

FIG. 2 is a flowchart representing a method for optimizing a criterion or a combination of one or more criteria relating to the vehicle, implemented by the computer of FIG. 1, according to an aspect of the present invention.

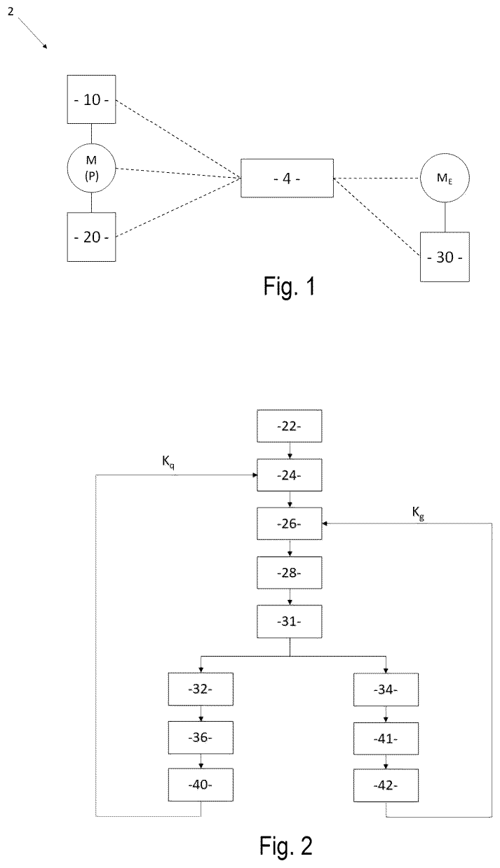

With reference to FIG. 2, an aspect of the present invention relates to a method, implemented in a computer 4 embedded within a motor vehicle 2 (shown in FIG. 1), for optimizing a criterion or a combination of criteria relating to the motor vehicle 2. The motor vehicle 2 is for example (but non-limitingly) a hybrid vehicle. In addition to the computer 4, such a hybrid vehicle 2 also conventionally comprises an internal combustion engine M (in the case of a “petroleum-electric” hybrid vehicle 2) often referred to as an ICE (acronym of internal combustion engine), or a fuel cell P that for example runs on hydrogen (in the case of a “hydrogen-electric” hybrid vehicle 2). Such a hybrid vehicle 2 further comprises at least one electric machine M_{E}, often referred to as an EMA (acronym of electric machine), a fuel tank or a hydrogen tank (not shown in FIG. 1) and an electrical supply battery 30 (or indeed super-capacitors in a variant that has not been shown).

The motor vehicle 2 also comprises at least one device relating to the internal combustion engine M and in particular a device 10 for cooling the internal combustion engine M and a catalytic converter 20, or at least one device relating to the fuel cell P (such a device has not been shown in FIG. 1). The cooling device 10 makes it possible to reduce the temperature of the internal combustion engine M during use thereof. The cooling device 10 in particular comprises a coolant. The catalytic converter 20, connected to the internal combustion engine M by the exhaust system, is capable of reducing the quantity of pollutants in the exhaust gases emitted by the internal combustion engine M before discharging them outside the vehicle. The catalytic converter 20 also comprises a heating device capable of increasing the temperature in the catalytic converter 20, in order to decrease pollution caused by the exhaust gases. The device for heating the catalytic converter 20 must be powered by electrical energy in order to operate. The motor vehicle 2 also comprises at least one device relating to the electric machine M_{E}, in particular a set of voltage converters (not shown in FIG. 1) making it possible to convert voltage between the battery 30 and the electric machine M_{E}. The motor vehicle 2 also comprises at least one device relating to the electric battery 30 (or to the super-capacitors), such a device having not been shown in FIG. 1 for the sake of clarity.

The internal combustion engine M is in particular capable of being powered with fuel supplied by the fuel tank, and the fuel cell P is capable of being powered by the hydrogen tank. The internal combustion engine M also comprises a system for exhausting the exhaust gases generated during combustion of the air-fuel mixture in the internal combustion engine M. The electric machine M_{E} is capable of being powered by electrical energy supplied by the battery 30.

The vehicle 2 may comprise other devices relating to the internal combustion engine M or fuel cell P, and other devices relating to the electric machine M_{E}.

The term “system” is used to designate all the elements mounted in the vehicle 2 that are capable of consuming or producing electrical power, fuel or hydrogen. For example, the system comprises all of the devices described above: the internal combustion engine M or the fuel cell P, the electric machine M_{E}, the cooling device 10, the catalytic converter 20, and the battery 30.

Each device is characterized by at least one state variable that makes it possible to describe the operating state of the device. For example, the cooling device 10 is characterized by a coolant temperature. By way of further example, the catalytic converter 20 is characterized by an internal temperature value. By way of further example, the battery 30 is characterized by a state-of-charge variable, the internal combustion engine M is characterized by a speed of rotation, the fuel cell P is characterized by a temperature or pressures in the hydrogen and oxygen supply circuits, etc.

The motor vehicle 2 further comprises means for measuring the one or more states described by the or each state variable and means for measuring the criterion or the combination of criteria to be optimized (such measuring means have not been shown in FIG. 1 for the sake of clarity). Preferably, the motor vehicle 2 also comprises means for measuring disturbances and/or setpoints applied to the vehicle 2 (for example such as torque and/or speed setpoints of the vehicle 2).

The criterion or the combination of one or more criteria to be optimized via the method according to an aspect of the present invention is for example an energy consumption of the vehicle 2, a pollution level of the vehicle 2, a state of health of the vehicle 2, or even a combination of at least two criteria relating to the vehicle 2 and selected from the group consisting of: a pollution level, an energy consumption, a state of health and a duration of a predetermined route. The criterion or the combination of one or more criteria to be optimized is represented by a criterion equation g(u,q). The criterion equation g(u,q) is dependent at least on instantaneous setpoint values u and the state variables q. Also preferably, the criterion equation is also dependent on disturbances and/or setpoints w applied to the vehicle 2, and is then written g(u,q,w).

The system is represented by a system of state equations f(u,q) modeling the dynamics of the vehicle 2. The state equations f(u,q) are dependent at least on instantaneous setpoint values u and the state variables q. Also preferably, the state equations are also dependent on disturbances and/or setpoints w applied to the vehicle 2, and are then written f(u,q,w).

The computer 4 is for example part of a data processing unit on which is stored an application or computer program capable of interacting with the computer 4 (the data processing unit and the application or computer program are not shown in FIG. 1 for the sake of clarity). As a variant, the application or computer program is stored directly in the computer 4. The computer 4 is connected to the internal combustion engine or to the fuel cell P, to the electric machine M_{E}, to the electric battery 30, and to all the devices described above, which in particular comprise the cooling device 10 and the catalytic converter 20.

The computer 4 is capable of receiving the measurement of each state-variable value relating to each device. In addition, the computer 4 is capable of controlling each device to which it is connected, through transmission of a setpoint, depending on the one or more values of the variables relating to said device.

Thus, for example, the setpoint transmitted to the internal combustion engine M designates the value of the torque to be applied to the internal combustion engine M and is in particular dependent on the speed of the vehicle and on the power required by the driver of the vehicle. By way of further example, the setpoint transmitted to the fuel cell P designates the power that the fuel cell P is required to provide and is dependent on the state of charge of the battery 30 and/or super-capacitors, and on the power required by the driver. By way of further example, the setpoint transmitted to the electric machine M_{E} designates the torque to be applied to the electric machine M_{E} and is dependent on the state of charge of the battery 30 and on the power required by the driver.

The setpoint transmitted to the catalytic converter 20 relates to the temperature in the catalytic converter 20 and is dependent on the temperature measured in the catalytic converter 20. The setpoint transmitted to the cooling device 10 relates to the temperature of the coolant and is dependent on the measured temperature of the coolant.

In one particular case, when the criterion to be optimized is the energy consumption of the vehicle 2, the energy consumption to be optimized may be the consumption of an electrical current delivered by the terminals of an electronic charger powering the electric battery 30 of the vehicle 2 (such terminals for example being electronic terminals of a bridge downstream of a bridge rectifier, and each comprising at least one controllable semiconductor switching device for powering the electric battery 30 during its charging phase). Each of the terminals of the electronic charger supplies an electrical current, the sum of the electrical currents supplied by the terminals then being represented by a setpoint to be transmitted to the electronic charger.

The computer 4 is also configured to determine the applicable setpoint range, which contains a set of values for each setpoint. The computer 4 is also configured to implement the principle of the PMP method, or in other words the method of Pontryagin's maximum principle, by determining the Hamiltonian function H(x, u*, λ) on the basis of the various setpoint values of the applicable setpoint range. The notation u*, which represents the optimum command, has been introduced here. Adjoint states ) have also been introduced (also referred to as “adjoint parameters”, “Lagrange parameters”, “adjoint vectors”, or indeed “co-state vectors”). These adjoint states are associated with the state equations representing the conditions of the dynamic behavior of the physical system, and will allow the optimization problem to be solved completely.

The computer 4 comprises a processor capable of implementing a set of instructions allowing these functions to be carried out.

With reference to FIG. 2, one embodiment of the method for optimizing a criterion or a combination of criteria of the vehicle 2 according to an aspect of the invention will now be described, the method being implemented by a computer 4 such as described above. In order to simplify the description, the criterion to be optimized is for example the energy consumption of the vehicle 2. Of course, any other criterion or combination of one or more criteria relating to the vehicle 2 may be optimized in the same way using the method illustrated in FIG. 2, and in particular a pollution level of the vehicle 2, a state of health of the vehicle 2, a duration of a predetermined route, or even a combination of at least two criteria relating to the vehicle 2 and selected from the group consisting of: a pollution level, an energy consumption, a state of health and a duration of a predetermined route.

In order to simplify the description, the various variables considered are as follows: the temperature of the coolant of the cooling device 10 and the state of charge of the battery 30 or of the super-capacitors. The various control setpoints considered are, for example: the torque of the internal combustion engine M and the torque of the electric machine M_{E}. Other parameters could be considered, in respect of the at least one device relating to the electric machine M_{E} or of parameters regarding the fuel cell P or the at least one device relating to the fuel cell P, or even parameters regarding the at least one device relating to the battery 30 or super-capacitors.

The method is implemented during a period divided into constant sampling times, and comprises steps that are looped through iteratively at each new sampling time. The sampling duration between two consecutive sampling times depends on the dynamics of the system and may for example be chosen to lie between 10 ms and 500 ms, but is typically equal to 100 ms.

The method comprises an initial step 22 in which the computer 4 determines an applicable setpoint range u containing a set of values for each setpoint u to be applied to the variables.

The method then comprises a subsequent step 24 in which the computer 4 computes, for each setpoint and in the determined applicable setpoint range u, all the state gradients possible for said setpoint, using at least the state equations f(u,q,w) describing the system. Preferably, in the computing step 24, the state gradients possible for each setpoint in the applicable setpoint range u are computed further using a first correction term K_{q}, the mode of computation of which term will be detailed below in the description of the comparing step 40. In the first iteration of the method, the first correction term K_{q} is initialized to a pre-parameterized value. The first correction term K_{q} is for example used in the computing step 24 via a mathematical relationship of addition or multiplication with the state equations f(u,q,w).

The method comprises a parallel or subsequent step 26 in which the computer 4 computes, for each setpoint and in the determined applicable setpoint range u, all the values possible for the criterion or the combination of criteria to be optimized, using at least the criterion equation g(u,q,w). Preferably, during computing step 26, the values possible for the criterion or the combination of criteria to be optimized for each setpoint in the applicable setpoint range u are computed further using a second correction term K_{g}, the mode of computation of which term will be detailed below in the description of the comparing step 42. In the first iteration of the method, the second correction term K_{g} is initialized to a pre-parameterized value. The second correction term Kq is for example used in the computing step 26 via a mathematical relationship of addition or multiplication with the criterion equation g(u,q,w). As a variant (not shown), the computing steps 24, 26 may be interchanged.

The method then comprises a subsequent step 28 in which the computer 4 computes, for each setpoint and in the determined applicable setpoint range u, all the possible values of a Hamiltonian function H(u,q,λ,w) of said setpoint, using the state-gradient values and the values possible for the criterion or the combination of criteria to be optimized determined for this setpoint. To do this, the computer 4 uses the principle of the PMP method, in other words the method of Pontryagin's maximum principle.

The Hamiltonian function H(u,q,λ,w) is then expressed as:

H(u,q,λ,w)=[g(u,q,w)+K_{g}]+λ^{T}·[f(u,q,w)+K_{q}]

with λ^{T} the transpose of the adjoint vector λ.

It will be noted that, when the route duration forms part of the one or more criteria to be optimized, the Hamiltonian function H(u,q,λ,w) is then expressed as:

H(u,q,λ,w)=[g(u,q,w)+K_{g}]+η+λ^{T}·[f(u,q,w)+K_{q}]

with η>0; ηthen being a weighting coefficient making it possible to weight the route duration.

The computer 4 then determines, in a subsequent step 31, all the setpoints said to be “optimum” u*, by minimizing, for each of the setpoints, the Hamiltonian function computed in the preceding step 28. In the considered example of embodiment, the computer 4 thus determines an “ICE” first optimum setpoint intended to control the internal combustion engine M, and an “electrical” second optimum setpoint intended to control the electric machine M_{E}.

Preferably, the method then comprises a subsequent step 32 in which the computer 4 computes, for each optimum setpoint u*, the state-gradient value for said setpoint u*, depending on the value of the setpoint u* determined in step 31.

Preferably, the method comprises a parallel or subsequent step 34 in which the computer 4 computes, for each optimum setpoint u*, the value of the or each criterion to be optimized for said setpoint u*, depending on the value of the setpoint u* determined in step 31. As a variant (not shown), the computing steps 32, 34 may be interchanged.

When the method comprises the computing step 32, the method comprises a subsequent step 36 in which the computer 4 carries out an integration as a function of time of the state-gradient value computed in step 32. This step 36 of integrating as a function of time provides an estimated value of the state vector.

The method then comprises a subsequent step 40 in which the computer 4 compares the state-vector value estimated in the preceding step 36 with a state-vector value measured by the measuring means of the motor vehicle 2. The difference between the two values provides the first correction term K_{q}. At the end of this comparing step 40, the first correction term K_{q} is provided as input to the computing step 24 at the next sampling time.

When the method comprises the computing step 34, the method comprises a subsequent step 41 in which the computer 4 carries out an integration as a function of time of the value of the or each criterion to be optimized computed in step 34. This step 41 of integrating as a function of time provides an estimated overall (or cumulative) criterion value.

The method then comprises a subsequent step 42 in which the computer 4 compares, for the or each criterion to be optimized, the overall criterion value estimated in the preceding step 41 with a criterion value measured by the measuring means of the motor vehicle 2. The difference between the two values provides the second correction term K_{g}. At the end of this comparing step 42, the second correction term K_{g} is provided as input to the computing step 26 at the next sampling time.

Preferably, each of the comparing steps 40, 42 is implemented via proportional-integral-derivative regulation, by a regulator embedded within the vehicle 2, or via state-variable re-estimation, or by any other computational means for achieving feedback known to those skilled in the art and providing a correction value to be applied at each time to reduce the error between estimation and measurement.

The method may be reiterated during use of the vehicle.

The method thus makes it possible to obtain setpoint values for which the pollution level, and/or energy consumption, and/or decrease in the state of health of the vehicle 2, and/or route duration are minimal.

In addition, the method makes it possible, through computation and determination of the first and second correction terms K_{q}, K_{g}, which are fed back to the first computing steps 24, 26 via a feedback loop, to simulate the behavior of the model at each sampling time and to compare it in real time with the behavior of the physical system (namely the motor vehicle 2). This allows the parameters of the model to be adapted and to make them correspond better to the actual physical system. Such an optimum closed-loop control strategy (with feedback) is therefore self-adaptive, in the sense that the parameters of the model are adjusted at each sampling time depending on the behavior of the physical system, this making the method according to an aspect of the invention more accurate and/or more stable from the point of view of the optimization control strategy, compared to the methods of the prior art.

Furthermore, the method according to an aspect of the invention:
makes it possible to reuse of the internal PMP model known per se to achieve the adaptation to the real physical system (gradient computation). Only numerical integrations as a function of time (and means for performing them) are added to the computer 4, and to the prior-art PMP method, to achieve the self-adaptation;
is flexible and in particular is capable of selecting and/or adjusting various adaptations: to one or more states of the internal model, and/or to one or more terms of the criterion or the combination of criteria to be optimized;
makes better use of existing metric inputs (common states, and common criteria), with consolidation of the feedback-based control of the PMP optimization method.

1. A method, implemented in a computer embedded within a motor vehicle, for optimizing a criterion relating to the vehicle among the group consisting of:
a pollution level, an energy consumption, a state of health and a duration of a predetermined route, the vehicle comprising a fuel or hydrogen tank, an electric battery and/or super-capacitors capable of supplying electrical energy, an internal combustion engine powered by the fuel tank or a fuel cell powered by the hydrogen tank, at least one electric machine powered by electrical energy supplied by the battery and/or super-capacitors, at least one device relating to the internal combustion engine or to the fuel cell, at least one device relating to the electric machine, and at least one device relating to the electric battery or to the super-capacitors, the computer being configured to manage the powertrain of the motor vehicle on a predetermined route and being capable of controlling the internal combustion engine or fuel cell, electric machine and/or devices through transmission of a set of setpoints, the internal combustion engine or the fuel cell, the electric machine, and the devices each being characterized by at least one state variable, each state variable making it possible to describe the operating state of the device that it characterizes, the set consisting of the internal combustion engine or fuel cell, of the electric machine, and of the devices being represented by a system of state equations modeling the dynamics of the vehicle, said state equations being dependent at least on instantaneous setpoint values and the state variables, the criterion to be optimized being represented by a criterion equation dependent at least on instantaneous setpoint values and the state variables, the vehicle further comprising means for measuring the one or more states described by the or each state variable and means for measuring the criterion to be optimized, said method being implemented during a period divided into constant sampling times, the method comprising, at each sampling time, the steps of:
a) determining an applicable setpoint range containing a set of values for each setpoint,
b) computing, for each setpoint and in the determined applicable setpoint range, all the state gradients possible for said setpoint, using at least the state equations,
c) computing, for each setpoint and in the determined applicable setpoint range, all the values possible for the criterion to be optimized, using at least the criterion equation,
d) computing, for each setpoint and in the determined applicable setpoint range, all the possible values of a Hamiltonian function of said setpoint, using the state-gradient values and the values possible for the criterion to be optimized determined for said setpoint,
e) determining the value of each setpoint, in the determined applicable setpoint range, for which said Hamiltonian function is lowest,
f) computing, for each of the setpoints, depending on said determined value of the setpoint, the state-gradient value for said setpoint, and/or computing-(34), for each of the setpoints, depending on said determined value of the setpoint, the value of the criterion to be optimized for said setpoint,
g) integrating as a function of time the computed state-gradient value, so as to provide an estimated state value, and/or integrating as a function of time, for the criterion to be optimized, the computed value of that criterion, so as to provide an estimated overall criterion value,
h) comparing the estimated state value with a measured state value, the difference between the two values providing a first correction term, the first correction term thus determined being provided as input to computing step b) at the next sampling time and being used in said computing step b), and/or comparing the estimated overall criterion value with a measured criterion value, the difference between the two values providing a second correction term, the second correction term thus determined being provided as input to computing step c) at the next sampling time and being used in said computing step c).

2. The method as claimed in claim 1, making it possible to optimize a combination of at least two criteria relating to the vehicle and selected from the group consisting of: a pollution level, an energy consumption, a state of health and a duration of a predetermined route, the method comprising, at each sampling time, the steps of:
aa) determining an applicable setpoint range containing a set of values for each setpoint,
bb) computing, for each setpoint and in the determined applicable setpoint range, all the state gradients possible for said setpoint, using at least the state equations,
cc) computing, for each setpoint and in the determined applicable setpoint range, all the values possible for the combination of criteria to be optimized, using at least the criterion equation,
dd) computing, for each setpoint and in the determined applicable setpoint range, all the possible values of a Hamiltonian function of said setpoint, using the state-gradient values and the values possible for the combination of criteria to be optimized determined for said setpoint,
ee) determining the value of each setpoint, in the determined applicable setpoint range, for which said Hamiltonian function is lowest,
ff) computing, for each of the setpoints, depending on said determined value of the setpoint, the state-gradient value for said setpoint, and/or computing, for each of the setpoints, depending on said determined value of the setpoint, the value of each criterion of the combination of criteria for said setpoint,
gg) integrating as a function of time the computed state-gradient value, so as to provide an estimated state value, and/or integrating as a function of time, for each criterion of the combination of criteria, the computed value of that criterion, so as to provide an estimated overall criterion value,
hh) comparing the estimated state value with a measured state value, the difference between the two values providing a first correction term, the first correction term thus determined being provided as input to computing step bb) at the next sampling time and being used in said computing step bb), and/or comparing, for each criterion of the combination of criteria, the estimated overall criterion value with a measured criterion value, the difference between the two values providing a second correction term, the second correction term thus determined being provided as input to computing step cc) at the next sampling time and being used in said computing step cc).

3. The method as claimed in claim 1, wherein the first correction term or second correction term, respectively, is used in the computing step via a mathematical relationship of addition or multiplication with the state equations or with the criterion equation, respectively.

4. The method as claimed in claim 1, wherein the or each comparing step is implemented via proportional-integral-derivative regulation, by a regulator embedded within the vehicle, or via state-variable re-estimation.

5. A computer for managing the powertrain of a motor vehicle on a predetermined route, the vehicle comprising, in addition to the computer, a fuel or hydrogen tank, an electric battery and/or super-capacitors capable of supplying electrical energy, an internal combustion engine powered by the fuel tank or a fuel cell powered by the hydrogen tank, at least one electric machine powered by electrical energy supplied by the battery and/or super-capacitors, at least one device relating to the internal combustion engine or to the fuel cell, at least one device relating to the electric machine, and at least one device relating to the electric battery or to the super-capacitors, the computer being capable of controlling the internal combustion engine (M) or the fuel cell, the electric machine and/or devices through transmission of a set of setpoints, the internal combustion engine or the fuel cell, the electric machine, and the devices each being characterized by at least one state variable, each state variable making it possible to describe the operating state of the device that it characterizes, the set consisting of the internal combustion engine or fuel cell, of the electric machine, and of the devices being represented by a system of state equations modeling the dynamics of the vehicle, said state equations being dependent at least on instantaneous setpoint values and the state variables, the vehicle further comprising means for measuring the one or more states described by the or each state variable and means for measuring a criterion or a combination of criteria of the vehicle to be optimized, the computer configured to implement the steps of the method as claimed in claim 1.

6. A motor vehicle comprising a fuel or hydrogen tank, an electric battery and/or super-capacitors capable of supplying electrical energy, an internal combustion engine powered by the fuel tank or a fuel cell powered by the hydrogen tank, at least one electric machine powered by electrical energy supplied by the battery and/or the super-capacitors, at least one device relating to the internal combustion engine or to the fuel cell, at least one device relating to the electric machine at least one device relating to the electric battery or to the super-capacitors, and a computer for managing the powertrain of a motor vehicle on a predetermined route, the computer being capable of controlling the internal combustion engine or fuel cell, electric machine and/or devices through transmission of a set of setpoints, the internal combustion engine or the fuel cell, the electric machine, and the devices each being characterized by at least one state variable, each state variable making it possible to describe the operating state of the device that it characterizes, the set consisting of the internal combustion engine or fuel cell, of the electric machine, and of the devices being represented by a system of state equations modeling the dynamics of the vehicle, said state equations being dependent at least on instantaneous setpoint values and the state variables, the vehicle further comprising means for measuring the one or more states described by the or each state variable and means for measuring a criterion or a combination of criteria of the vehicle to be optimized, and a computer for managing the powertrain as claimed in claim 5.

7. A computer program product, comprising a set of program code instructions, which, when executed by one or more processors, configure the one or more processors to implement the method as claimed in claim 1.

8. The method as claimed in claim 2, wherein the first correction term or second correction term, respectively, is used in the computing step via a mathematical relationship of addition or multiplication with the state equations or with the criterion equation, respectively.
